(19) United States
(12) Patent Application Publication
(10) Pub. No.: US 2013/0014681 A1
(43) Pub. Date: Jan. 17, 2013

(54) QUILT BLOCK PIECING SYSTEM

(71) Applicants: Lora Michelle Kennedy, Smithboro, IL (US); Virginia Lora Schewe, Smithboro, IL (US)

(72) Inventors: Lora Michelle Kennedy, Smithboro, IL (US); Virginia Lora Schewe, Smithboro, IL (US)

(73) Assignee: Lora Michelle Kennedy, Smithboro, IL (US)

(21) Appl. No.: 13/542,208

(22) Filed: Jul. 5, 2012

Related U.S. Application Data
(60) Provisional application No. 61/482,324, filed on Jul. 11, 2011.

(51) Int. Cl. D05B 11/00; B43L 7/00

(52) U.S. Cl. 112/475.08; 33/566

(57) ABSTRACT

A preprinted foundation for assembling a quilt block from a plurality of pieces of fabric, the foundation comprising indicia indicating an order of assembly of said pieces of fabric and a position of said fabric pieces to form the quilt block and a method of using same.

### CROSS-REFERENCE TO RELATED APPLICATIONS

This application claims the benefit of provisional application Ser. No. 61/482,324, filed Jul. 11, 2011, which is incorporated herein by reference.

### BACKGROUND OF THE INVENTION

The disclosure relates generally to a system for simplifying cutting and assembling fabric pieces to make quilt blocks.

It is known that quilts, particularly hand-made quilts, comprise a plurality of quilt blocks that are sewn together to form the top or decorative layer of a quilt. In general, pieces of fabric are usually joined with right sides together and raw edges even, using a process in quilt making referred to as “piecing”. When making quilts the pieces of fabric may be all the same size, or different shapes that fit together to form “blocks” that will be put together to form a “quilt top”. The blocks do not necessarily have to all be the same size, but the piecing process is easier if they are the same size. Precise block sizes are required to be able to have a finished quilt top that is aesthetically pleasing.

Also, it is often difficult to keep the piecing sequence of intricate quilt blocks in an ordered fashion regardless of whether the blocks are pieced together all at one time or pieced intermittently over a longer period of time. Fabric is usually known as having “right side” and a “wrong side”. The right side is the one that has the more vibrant pattern or color. The wrong side is the opposite or back of the fabric. Generally, fabric pieces are layered right sides together to sew a seam. Sewing fabric together to form a quilt top of any size or shape requires that a margin be added for the seam, this is usually a quarter inch (¼″) and is called a ‘seam allowance’. An accurately sewn seam can be achieved in several ways. The first is by sewing on a line drawn on the wrong side of the fabric so that the person sewing the seam can see it. The second is to use the measurement lines already on the feed dog cover plate of a sewing machine. A third method is to mark the pressure foot of the sewing machine for the seam allowance desired and then use this mark to sew all the seams needed to complete the project. All these methods are machine and/or operator dependent. Therefore, no two completed blocks will be the same, even if the same person pieces them all.

Fabric pieces need to be cut along the ‘straight grain’ of the fabric making the edges parallel to the thread in the woven fabric. Cutting along the straight grain ensures minimal stretch and distortion of the fabric pieces, resulting in a higher quality and more pleasing appearance to the finished project. However, numerous pieces in multiple quilt blocks cannot always be cut on the ‘straight grain’ due to that block's angle requirements which may not follow the woven threads of the fabric.

Historically, quitters used a pattern or template, usually made of cardboard or, in recent years, plastic. They employed these templates to cut the fabric for their quilt designs, and to mark stitching lines. Cardboard templates can abrade or get smaller as a result of use due to the pressure of the pencil against the side of the cardboard template. Repeated use of a cardboard template can result in progressively smaller and smaller pieces. These smaller pieces will give smaller finished blocks and the blocks will not fit together properly, resulting in an inferiorly finished project. Using plastic templates can prevent the shrinkage of the template. In any event, marking and cutting all the pieces individually is extremely time-consuming.

The quilter may measure and draw the shapes necessary to make her own templates. These templates may be traced onto template material like thin plastic, heat-resistant plastic, adhesive labels, cardboard, paper, freezer paper and others. For many quilt blocks with numerous, odd shaped pieces this process of making the numerous templates needed, then adding the seam allowances to the templates, and cutting each one out and keeping them in proper sewing order is tedious and time consuming.

Until the 1980s, when the rotary cutter was introduced, quilters cut out the pieces of fabric with scissors. A rotary cutter is an alternative to the scissors. It is similar in construction and use to a pizza cutter. It generally is used with a self-healing plastic mat and a straight edge, which is typically an acrylic ruler. Slicing through multiple layers of fabric with a rotary cutter and a specialty ruler is faster than cutting with scissors. However, accurate measuring and cutting is important but can be difficult. The precision necessary for cutting fabric for quilt block is demanding.

Aligning a ruler on the correct straight grain is confusing. It is important to be correct, but choosing to be on straight grain is not obvious, especially to beginners. For example, straight grain of the fabric on right-angle triangle pieces should sometimes be on the longest edge and sometimes on the two shorter sides, depending on the placement of the triangle in the quilt block. An error makes it more difficult to stitch without distortion and reduces the quality and pleasing appearance of the finished quilt.

For foundation piecing, also called paper piecing, the quilter prints or traces precise outlines and numbers onto a foundation to indicate the edge of each piece and the correct sewing sequence. The foundation can be paper, lightweight interfacing, water-soluble paper or fabric, fabric, or other specialty paper.

The user stitches along the marked lines through layers of fabric and the foundation, adding pieces in a specific order. A paper foundation is removed when the quilt block is completed, before attaching it to other quilt blocks to form the whole quilt top or other fabric item. Removing the foundation can be very time-consuming and frustrating, as it often requires the use of tweezers.

If using water-soluble paper or fabric for the foundation, these foundations must be protected from steam irons or drops of water of any sort. Adding water, whether directly or as steam, will distort and render the foundation useless. This is costly and frustrating to have something become useless so easily.

Using fabric for the foundation adds to the problem of fluidity of woven fabric. Fabric has some stretch in every direction and therefore the innate characteristics of fluidity. This fluidity in the foundation coupled with the fluidity of the small pieces that are to form the quilt top only allow the most accomplished of quitters to complete blocks that are all square and the same size. Also, with foundation piecing, the quilter is always working in the mirror image of the finished design, so it is even more difficult than usual to cut pieces on the straight grain. Mistakes waste fabric or reduce the durability and quality of the finished project.

Foundation piecing uses more fabric that other methods because there are no instructions or marks to guide the user in cutting pieces to cover each area of the foundation. The user is expected to cut fabric pieces too big and then trim. This is extra work and results in unusable scraps. Stitching along the line on the foundation allows the user to achieve greater precision, but a significant amount of fabric is wasted.

Printing decorative or informational elements on clothing and quilts is known. Manufacturers of inkjet printers, for example, promote printing decorations on fabric for quilts and other fabric projects. There is design software for quilters that print designs onto paper or other media that have been stiffened for the purpose of feeding. Current quilting software does not give the user the ability to print registration or matching marks, marked sewing and cutting lines, so these must be added manually to the templates.

While these programs can be used to provide a piecing sequence of the blocks, there is no guidance on color placement. The desirability of a quilt pattern is solely reliant on its color placement, or color options as displayed by the designer. Therefore, color placement notation would be an extremely desirable quality in a foundation.

Preparation steps must be repeated each time a different quilt design is desired. It is very time consuming to create the templates and make sure the math is correct to add proper seam lines as well as registration points, and making the calculations to efficiently use fabric.

Although stitching and cutting lines are printed in black ink, which is the most permanent, presently available printed foundations contain lines that are heavier than what is desirable for printed guidelines for sewing. These heavy lines give the sewer much too wide an area for making the seam. This results in seam lines that are wavy when sewn and will not fit together with the adjacent pieces.

The problems associated with paper templates include 1) paper can cut the seamstress if proper care is not exercised when handling the paper, 2) the paper does not retain its full measurement when it is folded or crinkled in any way; and 3) paper is not a normal medium for sewing and requires needle replacement quite frequently.

It would be advantages to have system and method for piecing quilt blocks that are simpler to prepare, easier to use, allows the quilter to work at her own pace and within time frame requirements, and result in a finished quilt top without having to use specialty rulers or other tools.

### SUMMARY OF THE INVENTION

One aspect of the disclosure is to provide a foundation material and markings on the foundation material to make quilt blocks easy to piece together.

Another aspect of the present disclosure is to provide a preprinted foundation, with indicia on each foundation that give the piecing sequence as well as the characteristics of the fabric required for that block, thereby allowing quilters at a beginner and advanced beginner status to piece a quilt top that is traditionally difficult and yet achieve success.

An additional aspect of the present disclosure is to allow the quitter to piece quilt blocks in stages, as time permits, complete the project with minimal frustration.

Another aspect of the disclosure is that the foundation material used accepts the ink and does not allow it to be transferred to any other surface at any other time

### BRIEF DESCRIPTION OF THE DRAWINGS

FIG. 1 is a twelve inch Stable Piecing Foundation in a pineapple block pattern.

### DETAILED DESCRIPTION

In general, the present disclosure provides a product and method for simplified piecing of a quit block. As used herein, the terms “user” or “quilter” or “piecer” or “seamstress” are intended to encompass anyone who uses the disclosed system to construct quilt blocks and are not intended to be limiting in anyway, including limitation to a specific gender.

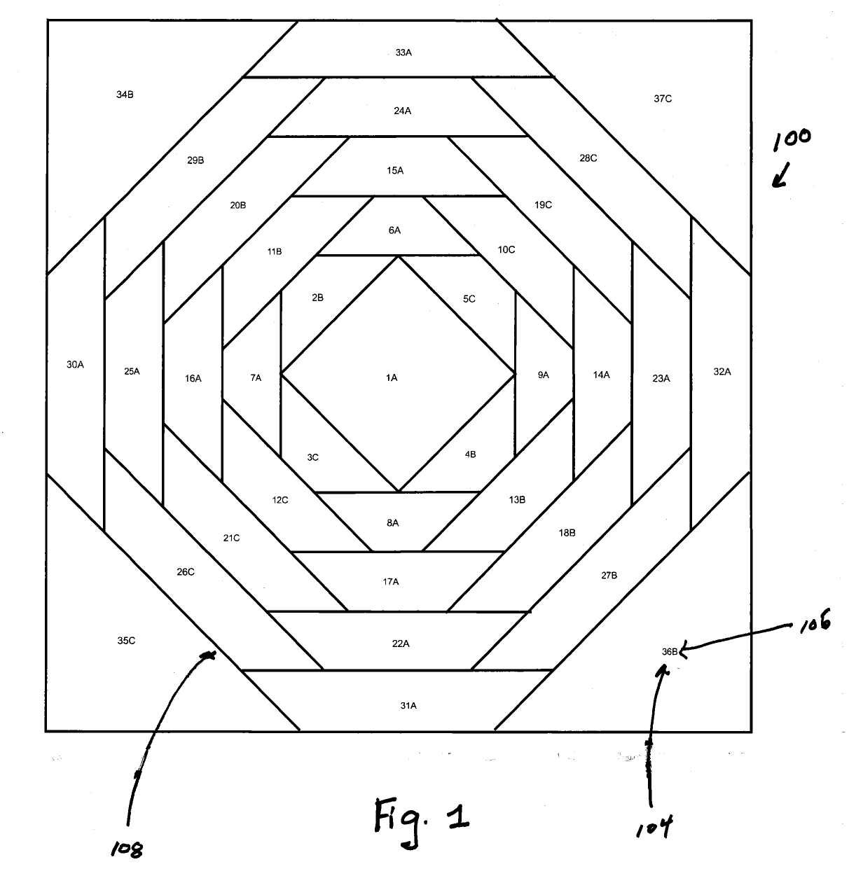

The system include a product, referred to generally as a Stable Piecing Foundation (“SPF”), one embodiment of which is disclosed as a twelve inch Pineapple pattern SPF, indicated generally by reference number 100, in FIG. 1. In one aspect of the invention, SPF 100 is constructed from sheets of fabric stabilizer comprised of polyester and cellulose fibers. SPF 100 further comprises the following:
Blocks 102 with indicia printed on them.
In one aspect, the indicia are Arabic numbers 104.
In another aspect the numbers 104 denote the order in which the pieces of fabric are added.
In another aspect, the indicia are letters 106.
In one aspect, the letters denote the characteristics of the fabric, such as the type of fabric, colors or shades, prints or patterns.
The indicia also include lines 108 separating each fabric piece in the quilt block. Lines 108 indicate sewing lines.
In another aspect, lines 108 can be cutting or trimming lines.

The foregoing indicia are printed on the SPF 100 in indelible, smear-proof or nontransferable ink such that printed indicia are not transferred to the fabric with which the SPF is being used.

In general, the basic steps of the method of using SPF 100 comprise:

Identifying a first piece of fabric for of the quilt block, said first piece of fabric identified as corresponding to indicia on a preprinted foundation;

cutting a piece of fabric to adequately cover a space on the preprinted foundation that corresponds to indicia for the first piece of fabric for the quilt block;

attaching the first piece of fabric on an unprinted side of foundation, thereby covering the space on the preprinted foundation that corresponds to indicia for the first piece of fabric for the quilt block;

identifying a second piece of fabric for the quilt block, said second piece of fabric identified as corresponding to indicia on the preprinted foundation; cutting a piece of fabric to adequately cover a space on the preprinted foundation that corresponds to indicia for the second piece of fabric for the quilt block;

aligning an edge of the second piece of fabric with an edge of the first piece of fabric;

attaching the second piece of fabric on the unprinted side of foundation, thereby covering the space on the preprinted foundation that corresponds to indicia for the second piece of fabric for the quilt block;

turning the foundation and attached fabric over such that sewing lines on the preprinted foundation face up;

sewing on a line connecting the first and second pieces; and

repeating foregoing steps until all pieces of fabric have been incorporated in into the quilt block.

In reference to FIG. 1, the system for constructing a quilt top using the disclosed SPF 100 more specifically is as follows:

The quilter begins with the first or center piece of the quilt block, indicated by reference number 1A on the SPF in FIG. 1. Each piece in the block has a number 104 indicating its place in the piecing sequence and a letter 106, denoting the fabric to be used for that particular piece. In the illustrated embodiment, the first piece is indicated by the number 1 and the particular characteristic of the fabric; the characteristic of the fabric being one or more of the type of fabric , the color of fabric, or the print (pattern) of choice, as denoted by the letter A. Hence, every piece that has an ‘A’ after the number comprises the same fabric or same color or pattern. Likewise, different letter designations indicate different fabrics in the block. For the pineapple block illustrated in FIG. 1, there are three fabrics: A, B and C.

In any event, the quitter begins by cutting a piece of fabric ‘A’ to adequately cover the space indicated by ‘1A’ plus a seam allowances. Using washable fabric glue or pins, piece 1A is placed on the unprinted side of SPF 100 covering the space labeled as ‘1A’ leaving the seam allowance to fall outside the sewing lines for this piece. The wrong side of the fabric is placed against the unprinted side of SPF 100. Piece 1A is glued or pinned in place.

With the printed side of the foundation up, a relatively flat straight edge, for example an index card or other straight edge is placed next to this sewing line 108 and SPF 100 is folded over the index card creating a straight and slightly elevated edge. Using another straight edge, for example a 6 inch or 12 length ruler, the user abuts the lip of ruler against this slight elevated edge. The quilter then cuts along the rulers' edge, preferably using a rotary cutter and an acrylic cutting mat, removing any excess fabric. There will be very little excess fabric to remove.

Next, the quitter cuts the piece of fabric for piece 2B according to the sizes given in the specific pattern directions. Making sure the foundation is now lying with the fabric facing up, the quilter align the longest cut edge of piece 2B with the edge of piece 1A that was just trimmed. Fabrics are to be placed right sides together.

The quilter next pins piece 2B in place. Turning the foundation over with the sewing lines facing up, the quilter sets her sewing machine stitch length to approximately 18 to 20 stitches to the inch or approximately 1.5-1.8 mm and sew on the line connecting pieces 1A and 2B. The quilter back tacks two or three stitches at the beginning of the seam. The line is sewn until it intersects with the next line. It is back tacked with two or three stitches at the end of this seam. The block is removed from the sewing machine and threads trimmed.

The next step is to press the newly sewn piece up into place. It should cover the area labeled as 2B on the SPF, including seam allowances. The quitter should avoid creating pleats next to the seam line during this pressing process. Pleats will result in the piece being too small and distort the design by having excess fabric in places it should not be.

It will be noted that when to adjacent pieces are sewn together along the sewing line, the thread will go through the fabric and the SPF. Because the stitches are approximately 18 to 20 stitches to the inch or approximately 1.5-1.8 mm and sew on the line connecting pieces 1A and 2B, it is possible to tear away the SPF by tearing through the perforations created by stitching. The foundation can be removed periodically to reduce the stiffness as the quilt top continues to expand or all at one time. Enough foundation should be left around the perimeter of the quilt top to keep the outer edges from stretching until all borders have been added. Then remove the remainder of the foundation.

The foregoing steps are repeated until all pieces have been properly added to the foundation. After all pieces have been sewn in place, the quilter trims the block to 12½×12½ W square. The blocks, after being trimmed, will fit together to form a completed quilt top.

The following general principles are employed in the use of the disclosed system:
1. All sewing is done with the SPF on top—the fabric is on the bottom next to the sewing machine bed.
2. In general, a stitch length of 1.5 to 1.8 on metric machines or 18 to 20 stitches to the inch is employed. The length should be short enough to remain sewn when the SPF is removed. The stitching preferably is a back stitch at the beginning and end of each seam.
3. To conserve fabric, pieces are cut as needed by measuring the size of the piece on the foundation and adding a generous ½ both ways for seam allowances.
4. The first piece to go on any foundation should extend beyond all sides of the area to be covered by approximately ¼.
5. This first piece is placed with the wrong side of the fabric against the unprinted side of the foundation behind the first or, shown as 1A in the drawing.
6. The first or piece 1A is pinned or glued in place. If pinning a flat head pin is preferred.
7. Position straight edge on the SPF 100 along the stitching line between pieces numbers 1 and 2.
8. Fold the foundation back over the straight edge on this line.
9. Butt the lip of a ruler against this fold. For example, an Add-A-Quarter™ ruler
10. Cut off any fabric that extends beyond the ruler. You now have an accurate ¼ seam allowance.
11.Cut a piece of fabric for piece number 2 with approximately ½″ larger than the area on SPF 100.
12. Align the cut edge of piece number 2 with the just-cut edge of piece number 1, having the right sides together ;
13. Pin in place.
14. Turn over so SPF 100 is on top and sew only on the line between pieces number 1 and number 2. Do not sew past the ends of this line. Back stitch at the beginning and end.
15. Turn over so the fabric is on top and open piece number 2 so it lies over the number 2 area of the foundation. This piece should have its wrong side against the unprinted side of the foundation.
16. Press and/or pin in place.
17. Turn over so SPF is on top. Fold SPF back on the line that will attach piece number 3. Use the card for a sharp fold and the ruler. Cut off any extra extending fabric.
18. Cut a piece of fabric for piece number 3 approximately ½″ larger than the area on the foundation.
19. Align the cut edge of piece #3 with edge cut in Step 18.
20. Pin in place and sew as before.
21. For each successive piece, trim the upcoming seam allowance to ¼″, align new piece, pin in place and sew only on that line. (Steps 11-18)
22. Continue to add pieces until the foundation is covered.
23. Make sure that at least ¼″ of fabric extends beyond all outer printed lines of foundation.
24. Machine bastes around the block slightly outside the outer printed line on foundation.
25. Trim block to ¼″ beyond outer printed lines on foundation.

No matter how many pieces are required for any foundation the procedures are the same—the quilter begins with piece number 1 and add pieces until all are on the foundation.

Only two (2) rulers are needed to complete quilt blocks using the disclosed system. They are two of the most commonly used rulers and include a straight ruler used to cut strips of fabric across the width of your yardage. For example, a 6×24 acrylic ruler works well. The other ruler is an Add-a-Quarter™ ruler in either 6″ or 12″ length. Either length ruler will work for all applications.

1. A preprinted foundation for assembling a quilt block from a plurality of pieces of fabric, the foundation comprising indicia indicating an order of assembly of said pieces of fabric and a position of said fabric pieces to form the quilt block.

2. The preprinted foundation of claim 1 further comprising indicia indicating at least one characteristic of the fabric.

3. The preprinted foundation of claim 2 wherein the characteristic of the fabric is one or more of the type of fabric, the color of the fabric and the pattern of the fabric.

4. The preprinted foundation of claim 1 further comprising indicia indicating at least one sewing line.

5. The preprinted foundation of claim 1 further comprising indicia indicating at least one cutting line.

6. The preprinted foundation of claim 1 wherein the indicia are numbers.

7. The preprinted foundation of claim 2 wherein the indicia indicating at least one characteristic of the fabric are letter.

8. A preprinted foundation for assembling a quilt block from a plurality of pieces of fabric, the foundation comprising indicia indicating an order of assembly of said pieces of fabric and a position of said fabric pieces to form the quilt bloc; indicia indicating at least one characteristic of the fabric; and indicia indicating at least one sewing line.

9. The preprinted foundation for assembling a quilt block of claim 8 further comprising indicia indicating at least one cutting line.

10. A method of assembling a quilt block from pieces of fabric for use in a quilt comprising a plurality of quilt blocks, the method comprising:
Identifying a first piece of fabric for of the quilt block, said first piece of fabric identified as corresponding to indicia on a preprinted foundation;
cutting a piece of fabric to adequately cover a space on the preprinted foundation that corresponds to indicia for the first piece of fabric for the quilt block;
attaching the first piece of fabric on an unprinted side of foundation, thereby covering the space on the preprinted foundation that corresponds to indicia for the first piece of fabric for the quilt block
identifying a second piece of fabric for the quilt block, said second piece of fabric identified as corresponding to indicia on the preprinted foundation;
cutting a piece of fabric to adequately cover a space on the preprinted foundation that corresponds to indicia for the second piece of fabric for the quilt block;
aligning an edge of the second piece of fabric with an edge of the first piece of fabric;
attaching the second piece of fabric on the unprinted side of foundation, thereby covering the space on the preprinted foundation that corresponds to indicia for the second piece of fabric for the quilt block
turning the foundation and attached fabric over such that sewing lines on the preprinted foundation face up;
sewing on a line connecting the first and second pieces; and
repeating foregoing steps until all pieces of fabric have been incorporated in into the quilt block.

11. The method of claim 10 wherein the step of sewing on a line connecting the first and second pieces further comprises sewing with approximately 18 to 20 stitches to the inch.

12. The method of claim 10 wherein the step of sewing on a line connecting the first and second pieces further comprises sewing with stitches having the length of approximately 1.5 mm to approximately 1.8 mm.

13. The method of claim 10 further comprising the step of removing the preprinted foundation from the pieces of fabric further by tearing through perforations in the preprinted foundation created by the step sewing on a line connecting the first and second pieces .
